(19) United States
(12) Patent Application Publication
(10) Pub. No.: US 2005/0220203 A1
(43) Pub. Date: Oct. 6, 2005

(54) System & method for spreading on fading channels

(76) Inventor: Eric J. Ojard, San Francisco, CA (US)

Correspondence Address: MCANDREWS HELD & MALLOY, LTD, 500 WEST MADISON STREET, SUITE 3400, CHICAGO, IL, 60661, US

(21) Appl. No.: 10/877,638

(22) Filed: Jun. 25, 2004

Related U.S. Application Data
(60) Provisional application No. 60/557,946, filed on Mar. 31, 2004.

(51) Int. Cl. H04L 5/12

(52) U.S. Cl. 375/261

(57) ABSTRACT

This disclosure describes a simple spreading technique that improves performance for communication over fading channels with QPSK or BPSK modulation. The technique may comprise combining two symbols at the transmitter by applying a 2×2 transform, resulting in a 4-PAM or 16-QAM constellation. The receiver may utilize a 2-dimensional soft de-mapper to provide inputs to a soft-input decoder. This scheme can offer significant performance gains over fading channels with minimal additional complexity. This technique is most beneficial on systems with a weak code or no code at all. One application of this technique is for coded OFDM systems that experience frequency-selective fading. An example of such a system is the MBOA draft specification for UWB wireless communications.

### RELATED APPLICATIONS

This application makes reference to, claims priority to, and claims the benefit of U.S. Provisional Patent Application Ser. No. 60/557,946, entitled “System & Method For Spreading On Fading Channels” (Attorney Docket 15670US01 BP-3587), filed Mar. 31, 2004, the complete subject matter of which is hereby incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Many radio frequency (RF) communication systems experience fading of the transmitted symbols, where different symbols are received at different amplitudes (and/or different noise levels). One common example is Coded Orthogonal Frequency Division Multiplexing (Coded OFDM or COFDM) transmitted over a communications channel experiencing multi-path interference. In this example, the transmitted signal experiences frequency-selective fading. When the multi-path interference is sufficiently dense (i.e., the received signal comprises a very large number of signals, where each signal has a different path delay), the fading can be accurately modeled as Rayleigh fading.

The Multiband OFDM Alliance (MBOA) draft specification for Ultra-Wide-Band (UWB) communications is based on coded OFDM. The details of the draft specification for the IEEE 802.15.3a standard may be found in the document “Multi-band OFDM Physical Layer Proposal for IEEE 802.15 Task Group 3a”, document IEEE P802.15-03/268r2, dated Nov. 10, 2003, by the Institute of Electrical and Electronics Engineers, Inc., which draft specification is hereby incorporated herein by reference, in its entirety. Typical UWB channels exhibit large amounts of frequency-selective fading, which can often be accurately modeled as Rayleigh fading. At higher coding rates, the proposed specification listed above has relatively poor performance. Specifically, the 480 Mbps mode, which uses quadrature phase shift keyed (QPSK) modulation and a rate ¾ convolutional code, suffers a significant performance penalty in the presence of frequency-selective Rayleigh fading.

There have been several proposals for improving the performance of this mode of the draft specification. One such proposal calls for using 16-QAM (Quadrature Amplitude Modulation) modulation with a rate ⅜ code. This approach improves the performance significantly over Rayleigh-fading channels, but it harms the performance on non-fading channels and on channels with less-severe frequency-selective fading.

Another proposal calls for combining two symbols at the transmitter using a 2×2 Hadamard transform. The proposed approach combines two symbols that may experience different amounts of fading by multiplying by a 2×2 Hadamard Matrix:

$$[ \begin{matrix}{y}_{1} \\ {y}_{2}\end{matrix} ] = [ \begin{matrix}1 & 1 \\ 1 & - 1\end{matrix} ] [ \begin{matrix}{x}_{1} \\ {x}_{2}\end{matrix} ]$$

If the values x₁ and x₂ are assigned a value of −1 for a bit value of 0, and assigned a value of +1 for a bit value of 1, then the output values y₁ and y₂ take on ternary values. FIG. 1A shows the original 2-dimensional constellation of input values x₁ and x₂. FIG. 1B shows the same constellation when input values x₁ and x₂ are mapped to the real or imaginary parts of different complex signals. FIG. 1C shows the 2-dimensional constellation of y₁, and y₂. FIG. 1D shows the resulting constellation of a complex symbol in a passband system where y₁, and y₂ are mapped to the real or imaginary parts of different complex symbols. The resulting complex constellation is 9-QAM.

At the receiver, a 2-dimensional soft de-mapper may be used to provide inputs to a soft-input decoder such as, for example, a Viterbi decoder. This method performs better than 16-QAM with a rate ⅜ code on non-fading channels, but it doesn't achieve the same performance gains as 16-QAM on Rayleigh-fading channels.

FIG. 2A and FIG. 2B show the basic components of a transmitter 200A and a receiver 200B of a conventional Coded OFDM system using QPSK modulation. Current techniques to provide improved performance on Rayleigh-fading channels either harm the performance on non-fading channels or fail to achieve significant gains on Rayleigh-fading channels. Other possible techniques, such as stronger coding, can introduce significant complexity at the receiver.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Aspects of the present invention may be seen in a method of transmitting two bits using two symbols, where the two symbols can experience different amounts of fading. Such a method may comprise mapping the two bits to two symbols. In a representative embodiment of the present invention, the mapping may be characterized by a 4-point, 2-dimensional, square constellation rotated about the origin, and a projection of the 4-point, 2-dimensional, square constellation onto either axis may comprise a 1-dimensional constellation with 4 distinct points. The 4 distinct points of the 1-dimensional constellation may be uniformly spaced points. In a representative embodiment in accordance with the present invention, the method may also comprise transmitting the two symbols. The two bits may be the output of an interleaver, the two bits may be the output of an encoder employing a forward error correction (FEC) code, and the forward error correction code may comprise a convolutional code. The transmitting may use radio frequency (RF) communication, and each of the two symbols may be mapped to a different subcarrier of an orthogonal frequency division multiplexed (OFDM) communications link. In a representative embodiment in accordance with the present invention, the transmitting may be compatible with the Multi-band OFDM Physical Layer Proposal for IEEE 802.15 Task Group 3a.

Additional aspects of the present invention may be found in a system for transmitting two bits using two symbols, where the two symbols can experience different amounts of fading. A representative embodiment of the present invention may comprise at least one processor for processing the two bits for transmission, and the at least one processor may be capable of mapping the two bits to two symbols. The mapping may be characterized by a 4-point, 2-dimensional, square constellation rotated about the origin, and a projection of the 4-point, 2-dimensional, square constellation onto either axis may comprise a 1-dimensional constellation with 4 distinct points. The 4 distinct points of the 1-dimensional constellation may be uniformly spaced points. The at least one processor may be capable of transmitting the two symbols. Processing the two bits for transmission may comprise application of an interleaving algorithm. Processing the two bits for transmission may also comprise encoding the two bits employing a forward error correction (FEC) code, and the forward error correction code may comprise a convolutional code. In a representative embodiment of the present invention, the transmitting may comprise communicating the two symbols using radio frequency (RF) signals. Each of the two symbols may be mapped to a different subcarrier of an orthogonal frequency division multiplexed (OFDM) communications link, and the transmitting may be compatible with the Multi-band OFDM Physical Layer Proposal for IEEE 802.15 Task Group 3a.

Further aspects of the present invention may be observed in a machine-readable storage, having stored thereon a computer program having a plurality of code sections for implementing a method of transmitting two bits using two symbols, wherein the two symbols can experience different amounts of fading. The code sections may be executable by a machine for causing the machine to perform the operations comprising mapping the two bits to two symbols. The mapping may be characterized by a 4-point, 2-dimensional, square constellation rotated about the origin, and a projection of the 4-point, 2-dimensional, square constellation onto either axis may comprise a 1-dimensional constellation with 4 distinct points. The 4 distinct points of the 1-dimensional constellation may be uniformly spaced points. A representative embodiment of the present invention may also comprise transmitting the two symbols. A representative embodiment of the present invention may comprise processing the two bits using an interleaving algorithm, and encoding the two bits employing a forward error correction (FEC) code, where the forward error correction code may comprise a convolutional code. The transmitting may comprise communicating the two symbols using radio frequency (RF) signals, and the two symbols may be mapped to different subcarriers of an orthogonal frequency division multiplexed (OFDM) communications link. The transmitting may be compatible with the Multi-band OFDM Physical Layer Proposal for IEEE 802.15 Task Group 3a.

Other aspects of the present invention may be seen in a system capable of modulating two data bits mapped as separate symbols for joint transmission over separate paths subject to different amounts of fading, where mapping of the two data bits to two symbols may be characterized by a 4-point, 2-dimensional, square constellation rotated about the origin. A projection of the 4-point, 2-dimensional, square constellation onto either axis may comprise a 1-dimensional constellation with 4 distinct points. The 4-point, 2-dimensional, square constellation may comprise a subset of a square, uniformly-spaced, 16-point constellation, and a projection of the 4-point, 2-dimensional, square constellation onto either axis may comprise a uniformly-spaced, 4-point constellation. In a representative embodiment of the present invention, the paths may be separate subcarriers in a communication system using multi-band orthogonal frequency division multiplexing (OFDM).

Aspects of the present invention may also be found in a method of receiving two symbols to produce two data bits, where the two symbols are subject to different amounts of fading. Such a method may comprise estimating two fading amplitudes, receiving two symbols, jointly processing the received two symbols using the two fading amplitudes to produce two soft outputs, and decoding the two soft outputs using a forward error correction decoder. The decoding may comprise de-interleaving the two soft outputs, and decoding the de-interleaved two soft outputs to produce decoded output bits.

Still other aspects of the present invention may be seen in a machine-readable storage, having stored thereon a computer program having a plurality of code sections for implementing a method of receiving two symbols to produce two data bits, where the two symbols are subject to different amounts of fading. The code sections may be executable by a machine for causing the machine to perform the operations comprising estimating two fading amplitudes, receiving two symbols, jointly processing the received two symbols using the two fading amplitudes to produce two soft outputs, and decoding the two soft outputs using a forward error correction decoder. The decoding in a representative embodiment of the present invention may comprise de-interleaving the two soft outputs, and decoding the de-interleaved two soft outputs to produce decoded output bits.

Additional aspects of the present invention may be observed in a system for receiving two symbols to produce two data bits, where the two symbols are subject to different amounts of fading. Such a system may comprise at least one processor capable of estimating two fading amplitudes, and the at least one processor may be capable of receiving two symbols. The at least one processor may also be capable of jointly processing the received two symbols using the two fading amplitudes to produce two soft outputs, and the at least one processor may be capable of decoding the two soft outputs using a forward error correction decoder. The decoding may comprise de-interleaving the two soft outputs, and decoding the de-interleaved two soft outputs to produce decoded output bits.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1A shows an original 2-dimensional constellation of x₁ and x₂

FIG. 1B shows the same constellation of FIG. 1A when x₁ and x₂ are mapped to the real or imaginary parts of different complex signals.

FIG. 1C shows a 2-dimensional constellation of y₁ and y₂.

FIG. 1D shows the resulting constellation of a complex symbol in a passband system where y₁ and y₂ of FIG. 1A are mapped to the real or imaginary parts of different complex symbols.

FIG. 2A shows the basic components of a transmitter of a conventional Coded OFDM system using QPSK modulation.

FIG. 2B shows the basic components of a receiver of a conventional Coded OFDM system using QPSK modulation.

FIG. 3A shows an exemplary 2-dimensional constellation of two symbols, x₁ and x₂ that may correspond, for example, to the signal constellation shown in FIG. 1A.

FIG. 3B shows the constellation of FIG. 3A when the symbols, x₁ and x₂, are mapped to the real or imaginary parts of different complex signals.

FIG. 3C shows an illustration of an exemplary 2-dimensional constellation of symbols y₁ and y₂, in accordance with a representative embodiment of the present invention.

FIG. 3D shows the resulting constellation of a complex symbol in a passband system, where y₁ and y₂ may be mapped to the real or imaginary parts of different complex symbols, in accordance with a representative embodiment of the present invention.

FIG. 4A shows a constellation plot that illustrates the compression that occurs when one symbol experiences a deep fade while the other symbol is unaffected.

FIG. 4B shows a constellation plot that illustrates the compression that may occur when one symbol experiences a deep fade while the other symbol is unaffected, when a 2×2 Hadamard transform is used for spreading in the communication system of FIG. 4A.

FIG. 4C shows a constellation plot that illustrates the behavior in the presence of the same fading affecting the symbols of FIG. 4A, of a communication system in accordance with a representative embodiment of the present invention.

FIG. 5 shows curves illustrating the performance, in the presence of fading, of previously proposed alternatives for the 480 Mbps mode of the MBOA proposal, and a curve illustrating the performance of a communication system in accordance with a representative embodiment of the present invention.

FIG. 6 shows curves illustrating the performance, in the absence of fading, of the previously proposed alternatives for the 480 Mbps mode of the MBOA proposal, and a curve illustrating the performance of a communication system in accordance with a representative embodiment of the present invention.

FIG. 7A shows the basic components of a transmitter of an exemplary COFDM communication system, in accordance with a representative embodiment of the present invention.

FIG. 7B shows the basic components of a receiver of an exemplary COFDM communication system, in accordance with a representative embodiment of the present invention.

FIG. 8 is a flowchart that illustrates an exemplary method of transmitting two data bits on two symbols subject to different amounts of fading, in accordance with a representative embodiment of the present invention.

FIG. 9 is a flowchart that illustrates an exemplary method of receiving pairs of symbols transmitted by the method illustrated in FIG. 9, wherein the symbols are subject to different amounts of fading, in accordance with a representative embodiment of the present invention.

### DETAILED DESCRIPTION OF THE INVENTION

Aspects of the present invention relate in general to the transmission of data using a radio frequency communication system. More specifically, aspects of the present invention comprise a method of mapping data bits to information symbol values prior to transmission, in order to reduce the negative effects of fading upon the recovery of the information symbols at the receiver.

In a representative embodiment of the present invention, an improved encoding scheme may comprise combining two symbols, x₁ and x₂, that experience different amounts of fading, by multiplying them by a 2×2 matrix, as follows:

$$[ \begin{matrix}{y}_{1} \\ {y}_{2}\end{matrix} ] = [ \begin{matrix}2 & 1 \\ 1 & - 2\end{matrix} ] [ \begin{matrix}{x}_{1} \\ {x}_{2}\end{matrix} ] .$$

The above equation may also include a scaling factor in order to maintain the same transmitted power. In this case, this matrix multiplication results in a simple rotation of the point (x₁, x₂) and does not change the distance properties of the code. If, for example, the two symbols, x₁ and x₂, take on values from the set [−1, +1] mapped from the binary values of 0 and 1, then the outputs of the above transformation, y₁ and y₂, may take on values from the set [−3, −1, +1, +3]. Thus, the constellation that results from application of the transform may be 4-PAM (4-level pulse amplitude modulation), or 16-QAM (16-point quadrature amplitude modulation) in a passband system. This is convenient for practical implementations, since the values [−3, −1, +1, +3] may be represented by exactly two bits.

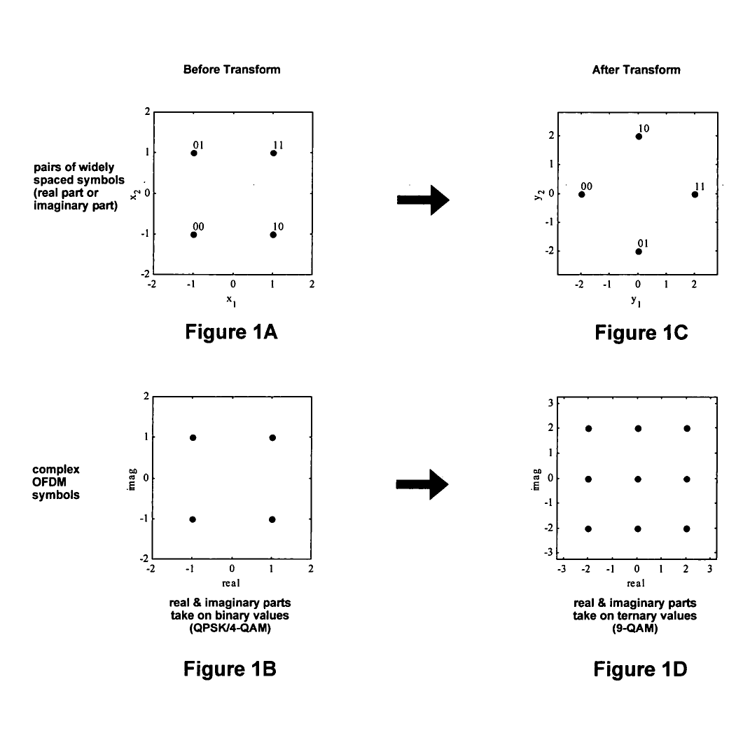

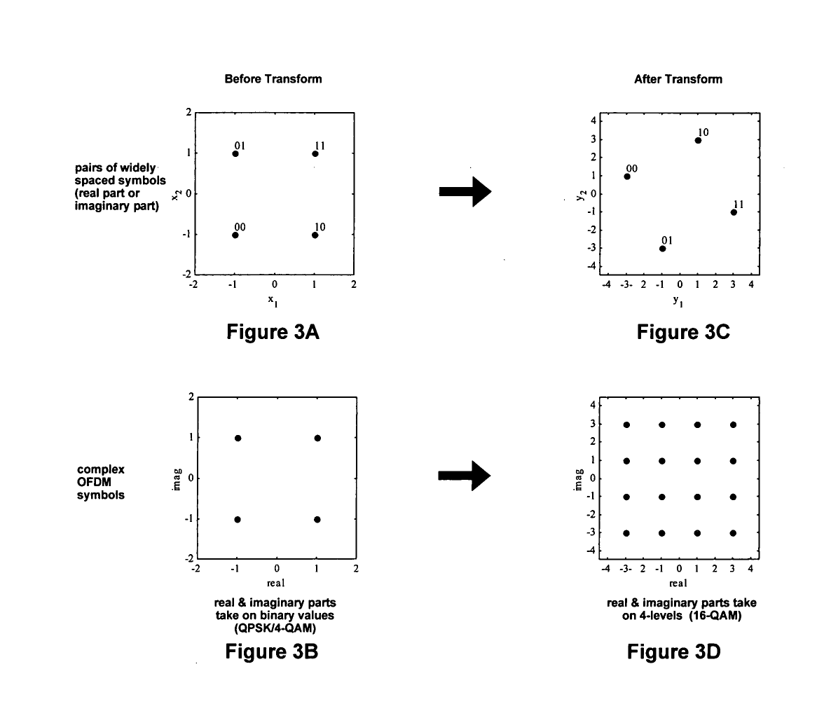

FIG. 3A shows an exemplary 2-dimensional constellation of two symbols, x₁ and x₂ that may correspond, for example, to the constellation shown in FIG. 1A. FIG. 3B shows the constellation of FIG. 3A when the symbols, x₁ and x₂, are mapped to the real or imaginary parts of different complex signals. FIG. 3C shows an illustration of an exemplary 2-dimensional constellation of symbols y₁ and y₂, in accordance with a representative embodiment of the present invention. The points in the constellation of FIG. 3C result from the application of the transform described above. As can be seen in FIG. 3C, this transform rotates the points about the origin. The rotation illustrated in FIG. 3C produces an arrangement of points in which a projection onto either axis results in a 1-dimensional constellation comprising four distinct and uniformly-spaced points. FIG. 3D shows the resulting constellation of a complex symbol in a passband system, where y₁ and y₂ may be mapped to the real or imaginary parts of different complex symbols, in accordance with a representative embodiment of the present invention. As shown, the resulting complex constellation is 16-QAM.

Note that the bit labeling shown in the figures is only for the purpose of illustration, as other bit labeling schemes may be used in a representative embodiment of the present invention, without affecting the performance. Also, the constellation illustrated in FIG. 3C may be flipped about either or both axes, or rotated by multiples of 90 degrees, without affecting the performance, and without deviating from the scope and spirit of the present invention.

In a representative embodiment of the present invention, a variety of methods may be used to decode symbols encoded as described above. A practical decoder that achieves good performance may comprise a 2-dimensional soft de-mapper. Such an approach may provide soft outputs to a soft-input decoder such as, for example, a Viterbi decoder. The two-dimensional soft de-mapper in a representative embodiment of the present invention may function according to the method described below.

Considering two transmitted symbols y₁ and y₂ from the 2-dimensional constellation shown in FIG. 3B, let a₁ and a₂ be the corresponding fade amplitudes (assumed to be approximately known from channel estimation), and let n₁ and n₂ be the corresponding noise on each received symbol, assumed to be additive white Gaussian noise (AWGN) with variance σ². Let z₁ and z₂ be the two received symbols.
z₁=a₁y₁+n₁
z₂=a₂y₂+n₂

Assuming the bit labeling of points shown in the constellation as shown in FIG. 3C, where bit #1 is the leftmost bit and bit #2 is the right-most bit in the label, the 2-dimensional soft de-mapper in a representative embodiment of the present invention may compute the values of the following two expressions:

$$LLR1 = Log [ \frac{{ⅇ}^{- ( {( {z}_{1} - 3 {a}_{1} )}^{2} + {( {z}_{2} + {a}_{2} )}^{2} ) / 2 {σ}^{2}} + {ⅇ}^{- ( {( {z}_{1} - {a}_{1} )}^{2} + {( {z}_{2} - 3 {a}_{2} )}^{2} ) / 2 {σ}^{2}}}{{ⅇ}^{- ( {( {z}_{1} + 3 {a}_{1} )}^{2} + {( {z}_{2} - {a}_{2} )}^{2} ) / 2 {σ}^{2}} + {ⅇ}^{- ( {( {z}_{1} + {a}_{1} )}^{2} + {( {z}_{2} + 3 {a}_{2} )}^{2} ) / 2 {σ}^{2}}} ]$$

$$LLR2 = Log [ \frac{{ⅇ}^{- ( {( {z}_{1} - 3 {a}_{1} )}^{2} + {( {z}_{2} + {a}_{2} )}^{2} ) / 2 {σ}^{2}} + {ⅇ}^{- ( {( {z}_{1} + {a}_{1} )}^{2} + {( {z}_{2} + 3 {a}_{2} )}^{2} ) / 2 {σ}^{2}}}{{ⅇ}^{- ( {( {z}_{1} + 3 {a}_{1} )}^{2} + {( {z}_{2} - {a}_{2} )}^{2} ) / 2 {σ}^{2}} + {ⅇ}^{- ( {( {z}_{1} - {a}_{1} )}^{2} + {( {z}_{2} - 3 {a}_{2} )}^{2} ) / 2 {σ}^{2}}} ]$$

Where LLR1 and LLR2 are log-likelihood ratios for bits 1 & 2, respectively.

These values may be used as inputs to a soft-input decoder such as, for example, a Viterbi decoder.

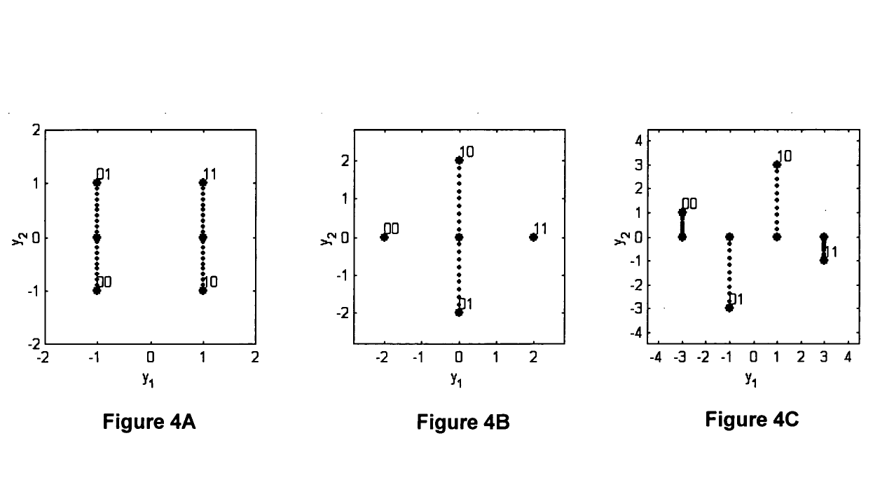

FIG. 4A shows a constellation plot that illustrates the compression that occurs when one symbol experiences a deep fade while the other symbol is unaffected. In the illustration of FIG. 4A, for example, the path carrying symbol y₂ is affected by a deep fade, while the path carrying symbol y₁ is unaffected. In a system according to the prior art, a deep fade causes the minimum distance between the points in the constellation to decrease proportionally with the fade amplitude, a₂, as illustrated in FIG. 4A.

FIG. 4B shows a constellation plot that illustrates the compression that may occur due to a deep fade of only one symbol, when a 2×2 Hadamard transform is used for spreading in the communication system of FIG. 4A. Beyond a certain fade depth, the minimum distance decreases proportionally with the fade amplitude, a₂, but the minimum distance remains greater than that of the non-spread system by a factor of √2, or 3 dB. This gives a communication system in which spreading is employed, an advantage over a non-spread communication system. In spite of this advantage, the minimum distance in a communication system employing spreading as described above still approaches zero as the fade amplitude of one path, in this example a₂, approaches zero.

FIG. 4C shows a constellation plot that illustrates the behavior in the presence of the fading affecting the signals of FIG. 4A, of a communication system in accordance with a representative embodiment of the present invention. It can be seen in the illustration of FIG. 4C that as the fade amplitude, a₂, (that is associated with y₂) decreases, the minimum distance decreases. It should be noted, however, that unlike the behavior illustrated in FIG. 4B, the minimum distance of the constellation shown in FIG. 4C does not approach zero. Only when both symbols experience deep fades, and the fade amplitudes, a₁ and a₂ of y₁ and y₂, respectively, approach zero, does the minimum distance approach zero. This behavior gives an embodiment of the present invention an advantage even over 2×2 Hadamard spreading.

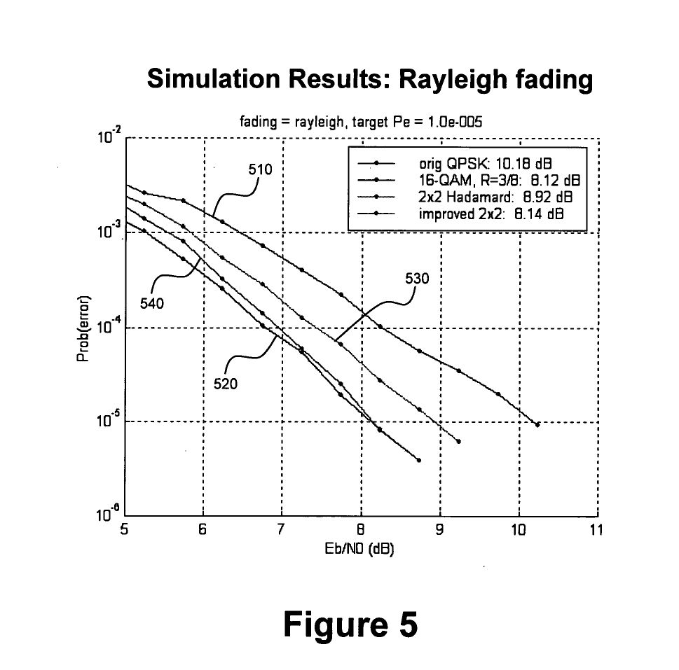

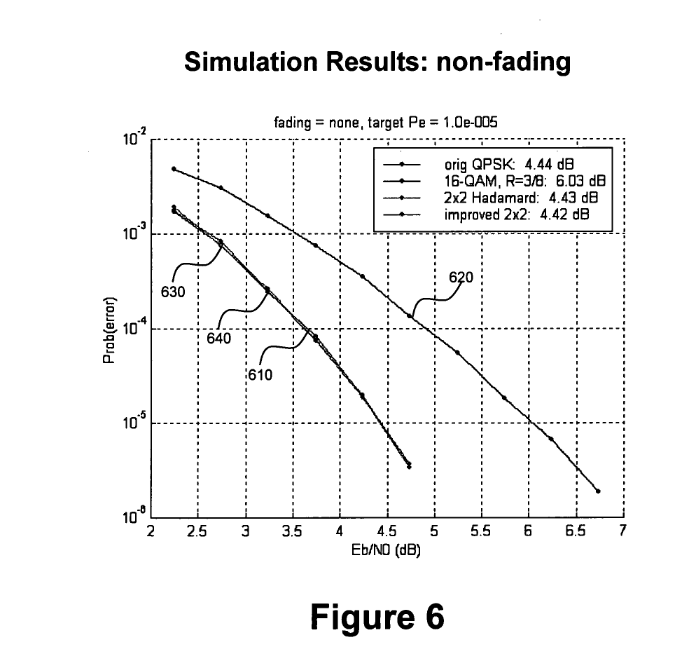

FIG. 5 shows curves 510, 520, 530 illustrating the performance, in the presence of fading, of previously proposed alternatives for the 480 Mbps mode of the MBOA proposal, and a curve 540 illustrating the performance of a communication system in accordance with a representative embodiment of the present invention. The simulation used to produce the results shown in FIG. 5 assumes independent Rayleigh fading, which represents a typical multi-band OFDM (MB-OFDM) UWB channel in a system with a well-designed interleaver. In contrast, FIG. 6 shows curves 610, 620, 630 illustrating the performance, in the absence of fading, of the previously proposed alternatives for the 480 Mbps mode of the MBOA proposal, and a curve 640 illustrating the performance of a communication system in accordance with a representative embodiment of the present invention. In the curves of both FIGS. 5 and 6, the Y axis represents the probability of decision error per bit. Curve 510 of FIG. 5 and curve 610 of FIG. 6 show the expected performance of the original proposed MBOA draft specification using QPSK with a rate ¾ convolutional code, in the presence or absence of fading, respectively. As can be seen in the illustration of FIG. 5, the proposed draft specification, as shown by curve 510, has a significantly higher probability of decision error per bit in the presence of Rayleigh fading, than the other approaches shown. Curve 520 of FIG. 5 and 620 of FIG. 6 show the expected performance in the presence and absence of fading, respectively, of an alternate proposal to use 16-QAM with a rate ⅜ code. As shown by curve 520 of FIG. 5, this approach may perform significantly better than the proposed MBOA draft specification, shown by curve 510, in situations experiencing Rayleigh fading. This alternate approach, however, may hurt performance when employed over non-fading channels, as shown by the significantly higher probability of decision error per bit, as illustrated by curve 620 of FIG. 6.

Curve 530 of FIG. 5 and 630 of FIG. 6 show the expected performance of an alternate proposal to use 2×2 Hadamard spreading, in the presence and absence of fading, respectively. This alternate approach performs better than the proposed MBOA draft specification when used over channels experiencing Rayleigh fading, as illustrated by curve 530 of FIG. 5, but does not perform nearly as well as the 16-QAM proposal, illustrated by curve 520.

Curve 540 of FIG. 5 and curve 640 of FIG. 6 show the expected performance in the presence and absence of fading, respectively, of a communication system in accordance with a representative embodiment of the present invention. This approach outperforms the 2×2 Hadamard spreading shown by curve 530 by a significant margin, and performs very near to the performance of the 16-QAM rate-⅜ proposal, as shown by curve 520. However, unlike the performance of the 16-QAM rate-⅜ proposal, the performance of an embodiment of the present invention is not diminished when used over non-fading channels. The superior performance in non-fading conditions of a embodiment of the present invention can be seen by comparing curve 640 of FIG. 6, to that of the 16-QAM rate 3/8 proposal, shown by curve 620 FIG. 6.

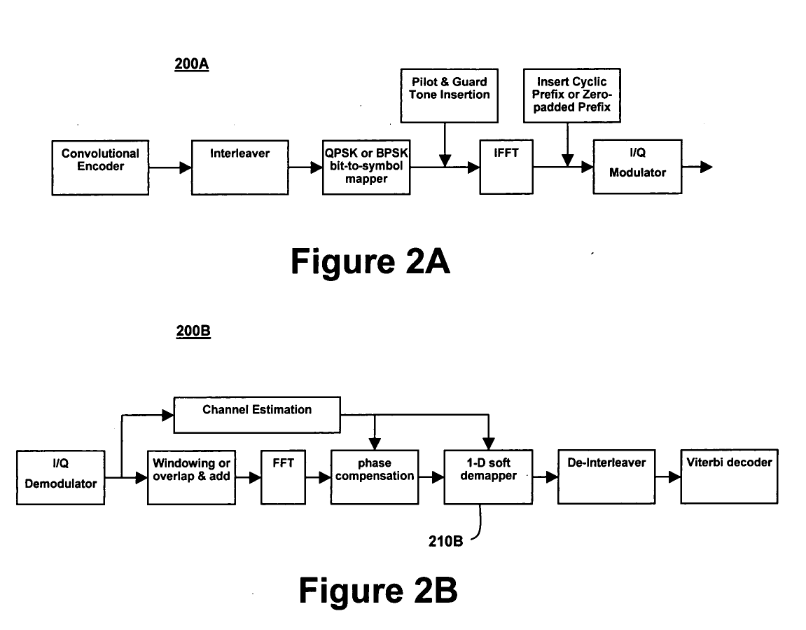

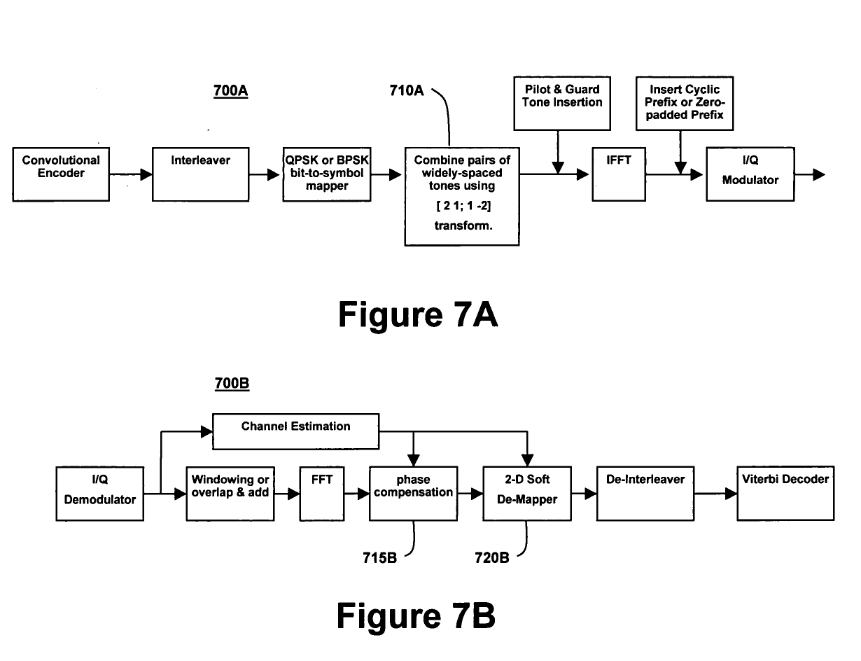

FIG. 7A and FIG. 7B show the basic components of a transmitter 700A and a receiver 700B of an exemplary OFDM communication system, in accordance with a representative embodiment of the present invention. The majority of the components of the transmitter 700A and receiver 700B of FIG. 7A and FIG. 7B, respectively, may correspond to the components of the transmitter 200A and receiver 200B of the communication system illustrated in FIG. 2A and FIG. 2B, respectively. However, in an embodiment in accordance with the present invention, pairs of widely-spaced subcarriers may be combined in the transmitter 700A by applying the transform 710A, described above, to the real and/or imaginary components separately. For optimal performance, the pairs of subcarriers may be chosen to maximize the distance between them in the frequency-domain. In a receiver in accordance with a representative embodiment of the present invention, such as the receiver 700B of FIG. 7B, the 1-dimensional soft de-mapper, that may correspond to the soft de-mapper 210B of FIG. 2, may be replaced by a 2-dimensional soft de-mapper, such as the 2-dimensional soft de-mapper 720B of FIG. 7, to operate as described above. The phase compensation block 715B may remove any phase rotation from the received symbol such that the real and imaginary components can be processed separately. The 2-D soft de-mapper 720B may then process the real and imaginary components, as previously described.

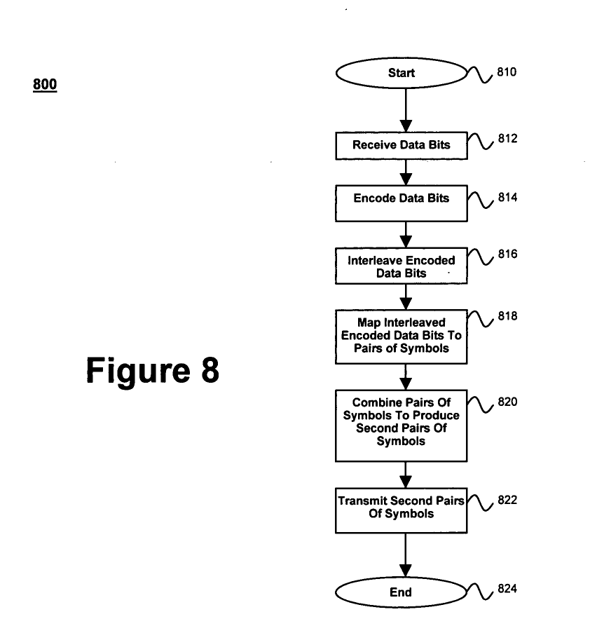

FIG. 8 is a flowchart 800 that illustrates an exemplary method of transmitting two data bits on two symbols subject to different amounts of fading, in accordance with a representative embodiment of the present invention. As illustrated in FIG. 8, the method begins (810), and a stream of pairs of data bits are received for transmission (812). Each bit in the pair of data bits may then be encoded (814) using an encoding algorithm such as, for example, convolutional coding, and the encoded data bits are interleaved (816). The pairs of interleaved data bits may then be mapped to pairs of symbols (818), and each pair of symbols may be combined (820) to form a new symbol pair using a transform such as that described above with respect to FIGS. 3C and 4C. The new pair of symbols is then transmitted (822). The method then ends (824).

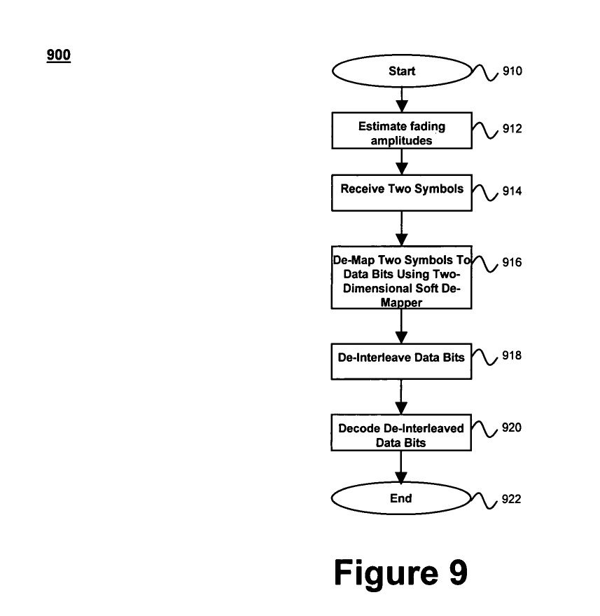

FIG. 9 is a flowchart 900 that illustrates an exemplary method of receiving pairs of symbols transmitted by the method illustrated in FIG. 9, wherein the symbols are subject to different amounts of fading, in accordance with a representative embodiment of the present invention. As illustrated in FIG. 9, the method begins (910), and an estimate of the fading amplitudes for the two symbols is made (912). The two symbols are then received (914). The two received symbols may then be de-mapped using a soft de-mapper (916) such as, for example, the soft de-mapper described above. Together, the two de-mapped symbols produce a pair of data bits. The pairs of data bits may then be de-interleaved (920), and decoded (922), reproducing a stream of pairs of data bits. The method then ends (924).

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method of transmitting two bits using two symbols, wherein the two symbols can experience different amounts of fading, the method comprising:
mapping the two bits to two symbols, wherein the mapping may be characterized by a 4-point, 2-dimensional, square constellation rotated about the origin, and wherein a projection of the 4-point, 2-dimensional, square constellation onto either axis comprises a 1-dimensional constellation with 4 distinct points; and
transmitting the two symbols.

2. The method of claim 1 wherein the two bits are the output of an interleaver.

3. The method of claim 1 wherein the two bits are the output of an encoder employing a forward error correction (FEC) code.

4. The method of claim 3 wherein the forward error correction code comprises a convolutional code.

5. The method of claim I wherein the transmitting uses radio frequency (RF) communication.

6. The method of claim 1 wherein each of the two symbols is mapped to a different subcarrier of an orthogonal frequency division multiplexed (OFDM) communications link.

7. The method of claim 1 wherein the transmitting is compatible with the Multi-band OFDM Physical Layer Proposal for IEEE 802.15 Task Group 3a.

8. The method of claim 1 wherein the 4 distinct points of the 1-dimensional constellation are uniformly spaced points.

9. A system for transmitting two bits using two symbols, wherein the two symbols can experience different amounts of fading, the system comprising:
at least one processor for processing the two bits for transmission;
the at least one processor capable of mapping the two bits to two symbols, wherein the mapping may be characterized by a 4-point, 2-dimensional, square constellation rotated about the origin, and wherein a projection of the 4-point, 2-dimensional, square constellation onto either axis comprises a 1-dimensional constellation with 4 distinct points; and
the at least one processor capable of transmitting the two symbols.

10. The system of claim 9 wherein processing the two bits for transmission comprises application of an interleaving algorithm.

11. The system of claim 9 wherein processing the two bits for transmission comprises encoding the two bits employing a forward error correction (FEC) code.

12. The system of claim 11 wherein the forward error correction code comprises a convolutional code.

13. The system of claim 9 wherein the transmitting comprises communicating the two symbols using radio frequency (RF) signals.

14. The system of claim 9 wherein each of the two symbols is mapped to a different subcarrier of an orthogonal frequency division multiplexed (OFDM) communications link.

15. The system of claim 9 wherein the transmitting is compatible with the Multi-band OFDM Physical Layer Proposal for IEEE 802.15 Task Group 3a.

16. The system of claim 9 wherein the 4 distinct points of the 1-dimensional constellation are uniformly spaced points.

17. A machine-readable storage, having stored thereon a computer program having a plurality of code sections for implementing a method of transmitting two bits using two symbols, wherein the two symbols can experience different amounts of fading, the code sections executable by a machine for causing the machine to perform the operations comprising:
mapping the two bits to two symbols, wherein the mapping may be characterized by a 4-point, 2-dimensional, square constellation rotated about the origin, and wherein a projection of the 4-point, 2-dimensional, square constellation onto either axis comprises a 1-dimensional constellation with 4 distinct points; and
transmitting the two symbols.

18. The machine-readable storage of claim 17 wherein the operations further comprise processing the two bits using an interleaving algorithm.

19. The machine-readable storage of claim 17 wherein the operations further comprise encoding the two bits employing a forward error correction (FEC) code.

20. The machine-readable storage of claim 19 wherein the forward error correction code comprises a convolutional code.

21. The machine-readable storage of claim 17 wherein the transmitting comprises communicating the two symbols using radio frequency (RF) signals.

22. The machine-readable storage of claim 17 wherein the two symbols are mapped to different subcarriers of an orthogonal frequency division multiplexed (OFDM) communications link.

23. The machine-readable storage of claim 17 wherein the transmitting is compatible with the Multi-band OFDM Physical Layer Proposal for IEEE 802.15 Task Group 3a.

24. The machine-readable storage of claim 17 wherein the 4 distinct points of the 1-dimensional constellation are uniformly spaced points.

25. A system capable of modulating two data bits mapped as separate symbols for joint transmission over separate paths subject to different amounts of fading, wherein mapping of the two data bits to two symbols may be characterized by a 4-point, 2-dimensional, square constellation rotated about the origin, and wherein a projection of the 4-point, 2-dimensional, square constellation onto either axis comprises a 1-dimensional constellation with 4 distinct points.

26. The system of claim 25 wherein the 4-point, 2-dimensional, square constellation comprises a subset of a square, uniformly-spaced, 16-point constellation, and wherein a projection of the 4-point, 2-dimensional, square constellation onto either axis comprises a uniformly-spaced, 4-point constellation.

27. The system of claim 25 wherein the paths are separate subcarriers in a communication system using multi-band orthogonal frequency division multiplexing (OFDM).

28. A method of receiving two symbols to produce two data bits, wherein the two symbols are subject to different amounts of fading, the method comprising:
estimating two fading amplitudes;
receiving two symbols;
jointly processing the received two symbols using the two fading amplitudes, to produce two soft outputs; and
decoding the two soft outputs using a forward error correction decoder.

29. The method of claim 28 wherein the decoding comprises:
de-interleaving the two soft outputs; and
decoding the de-interleaved two soft outputs to produce decoded output bits.

30. A machine-readable storage, having stored thereon a computer program having a plurality of code sections for implementing a method of receiving two symbols to produce two data bits, wherein the two symbols are subject to different amounts of fading, the code sections executable by a machine for causing the machine to perform the operations comprising:
estimating two fading amplitudes;
receiving two symbols;
jointly processing the received two symbols using the two fading amplitudes, to produce two soft outputs; and
decoding the two soft outputs using a forward error correction decoder.

31. The machine-readable storage of claim 30 wherein the decoding comprises:
de-interleaving the two soft outputs; and
decoding the de-interleaved two soft outputs to produce decoded output bits.

32. A system for receiving two symbols to produce two data bits, wherein the two symbols are subject to different amounts of fading, the system comprising:
at least one processor capable of estimating two fading amplitudes;
the at least one processor capable of receiving two symbols;
the at least one processor capable of jointly processing the received two symbols using the two fading amplitudes, to produce two soft outputs; and
the at least one processor capable of decoding the two soft outputs using a forward error correction decoder.

33. The system of claim 32 wherein the decoding comprises:
de-interleaving the two soft outputs; and
decoding the de-interleaved two soft outputs to produce decoded output bits.
